(19) United States
(12) Patent Application Publication
(10) Pub. No.: US 2026/0002638 A1
(43) Pub. Date: Jan. 1, 2026

(54) TANK

(71) Applicant: TOYOTA JIDOSHA KABUSHIKI KAISHA, Toyota-shi (JP)

(72) Inventor: Masayoshi TAKAMI, Hamamatsu-shi (JP)

(73) Assignee: TOYOTA JIDOSHA KABUSHIKI KAISHA, Toyota-shi (JP)

(21) Appl. No.: 19/077,741

(22) Filed: Mar. 12, 2025

(30) Foreign Application Priority Data
Jun. 27, 2024 (JP) 2024-104123

(51) Int. Cl. F17C 1/16

(52) U.S. Cl. CPC F17C 1/16; F17C 2201/0109; F17C 2203/0604; F17C 2203/0619; F17C 2203/0636; F17C 2203/066

(57) ABSTRACT

The present disclosure relates to a tank. The tank stores a fluid, and includes a tank body. The tank body defines a storage space for the fluid. The tank body includes a fiber-reinforced plastic layer and a metal layer. The metal layer is in contact with the fiber-reinforced plastic layer.

### CROSS-REFERENCE TO RELATED APPLICATION

This application claims priority to Japanese Patent Application No. 2024-104123 filed on Jun. 27, 2024. The disclosure of the above-identified application, including the specification, drawings, and claims, is incorporated by reference herein in its entirety.

### BACKGROUND

### 1. Technical Field

The present specification relates to a tank.

### 2. Description of Related Art

Japanese Unexamined Patent Application Publication No. 2004-183753 (JP 2004-183753 A) discloses a tank that defines a storage space for a fluid. The tank includes a fiber-reinforced plastic layer.

### SUMMARY

The fiber-reinforced plastic layer is formed by curing a resin that has been impregnated into fibers. Due to aging and other factors, the resin may peel off from the fibers. If cracks develop from points where the resin has peeled off from the fibers, the barrier performance of the tank may be reduced. The specification provides a technique for maintaining the barrier performance of a tank.

The present specification discloses a tank that stores a fluid. The tank includes a tank body that defines a storage space for the fluid. The tank body includes a fiber-reinforced plastic layer and a metal layer that is in contact with the fiber-reinforced plastic layer.

According to the above configuration, even when a crack develops in the fiber-reinforced plastic layer, the metal layer suppresses the fluid in the tank from permeating through the fiber-reinforced plastic layer. Accordingly, the barrier performance of the tank is maintained.

In addition, thermal conductivity of the metal layer is higher than that of the fiber-reinforced plastic layer. Adding the metal layer makes it possible to help transfer heat in the tank to the outside of the tank.

Furthermore, when cracks occur in the fiber-reinforced plastic layer, a load is also applied to the metal layer that is in contact with the fiber-reinforced plastic layer. By diagnosing sound caused by the load on the metal layer using the acoustic emission method (AE method), it is possible to detect signs of the development of cracks in the fiber-reinforced plastic layer. In particular, the breakage of the fibers and resin in the fiber-reinforced plastic layer is relatively instantaneous, whereas the breakage of the metal layer is relatively delayed. Although it is difficult to detect signs of the development of cracks using the AE method based on instantaneous sounds, it is possible to detect the signs using the AE method based on long sounds from the metal layer.

Details of the technique disclosed in the present specification and further improvements will be described in the “DETAILED DESCRIPTION OF EMBODIMENTS” below.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a side view of a tank;

FIG. 2 is a cross-sectional view taken along line II-II in FIG. 1;

FIG. 3 is an enlarged view of area III in FIG. 2;

FIG. 4 is an enlarged view according to a second embodiment; and

FIG. 5 is an enlarged view according to a third embodiment.

### DETAILED DESCRIPTION OF EMBODIMENTS

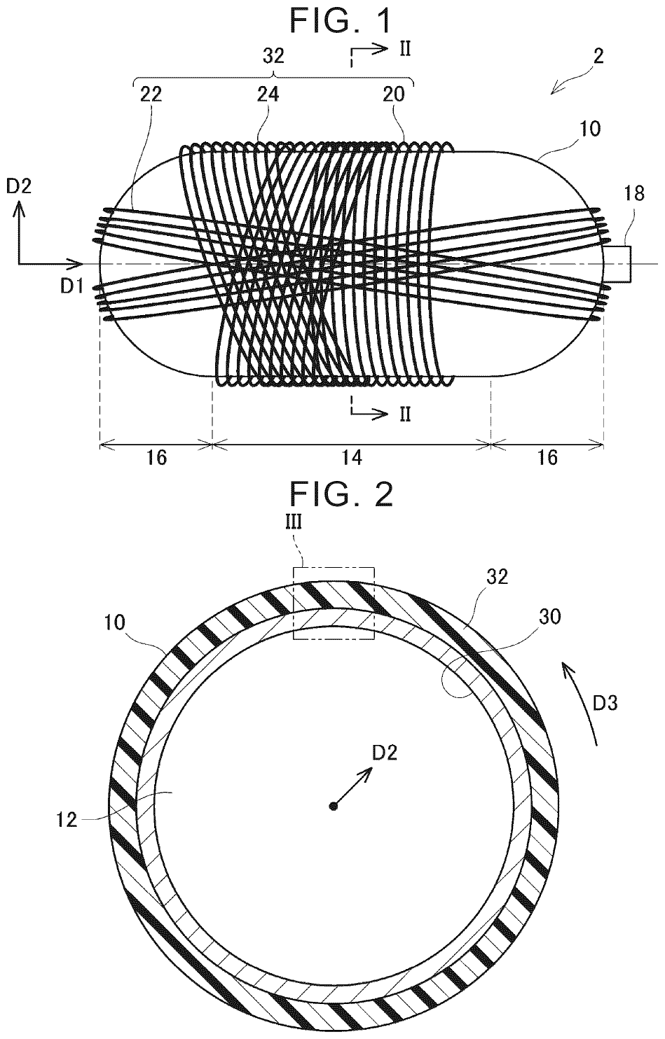

### Structure of Tank 2: FIGS. 1, 2, and 3

A tank 2 stores a fluid such as fuel. The fuel is, for example, high-pressure hydrogen gas, compressed natural gas, liquid hydrogen, or the like. The tank 2 is mounted on a vehicle, for example. The vehicle is, for example, an engine vehicle such as a fuel cell electric vehicle or a hydrogen vehicle. A cylindrical coordinate system (D1, D2, D3) is shown in the drawings. Directions D1, D2, and D3 represent an axial direction, a radial direction, and a circumferential direction, respectively. The axial direction D1 coincides with the axis of the tank 2.

The tank 2 includes a tank body 10 that defines a storage space 12 (see FIG. 2) for a fluid. The tank body 10 has a cylindrical portion 14, and a pair of dome portions 16. The dome portions 16 are provided on respective sides of the cylindrical portion 14 in the axial direction D1. One of the dome portions 16 is provided with a port 18. A fluid supply pipe (not shown) and a fluid discharge pipe (not shown) are connected to the port 18.

As shown in FIG. 2, the tank body 10 includes a liner layer 30 and a reinforcing layer 32. The liner layer 30 is in the form of the cylindrical portion 14 and the dome portions 16. The liner layer 30 is made of, for example, resin. The reinforcing layer 32 is formed by winding fiber-reinforced plastic filaments around the liner layer 30. The filaments are wound around the liner layer 30 by a so-called filament winding method.

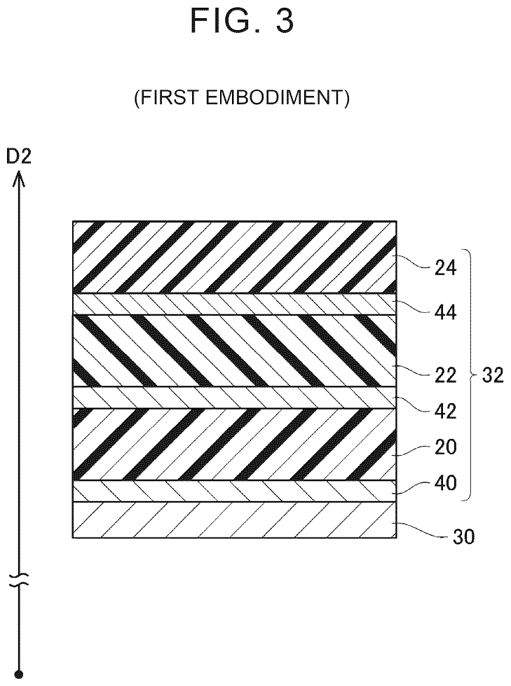

As shown in FIGS. 1 and 3, the reinforcing layer 32 includes a hoop layer 20, a first helical layer 22, and a second helical layer 24. The hoop layer 20 has a structure in which the fiber-reinforced plastic filaments are wound only around the cylindrical portion 14. In the hoop layer 20, the filaments are wound in a direction substantially perpendicular to the axial direction D1. “Substantially perpendicular” refers to an angle within a range of plus or minus a few degrees around 90 degrees. In the hoop layer 20, the filaments are wound around the liner layer 30 in a so-called hoop winding.

The first helical layer 22 has a structure in which the filaments are wound around the dome portions 16. In the first helical layer 22, the filaments are wound at a relatively small angle relative to the axial direction D1. In the second helical layer 24, the filaments are wound at a relatively large angle relative to the axial direction D1. The angle at which the filaments are wound in the second helical layer 24 is greater than the angle at which the filaments are wound in the first helical layer 22. In the second helical layer 24, the filaments are also wound around the dome portions 16 as well as the cylindrical portion 14. In the first helical layer 22 and the second helical layer 24, the filaments are wound around the liner layer 30 in a so-called helical winding.

In the hoop layer 20, the first helical layer 22, and the second helical layer 24, the filaments are wound without any gaps between them. As shown in FIG. 3, the hoop layer 20, the first helical layer 22, and the second helical layer 24 are laminated along the radial direction D2. In this embodiment, the hoop layer 20 is formed on the liner layer 30, the first helical layer 22 is formed on the hoop layer 20, and the second helical layer 24 is formed on the first helical layer 22. In a modification, the hoop layer 20 may be formed on the first helical layer 22 and the second helical layer 24, and the reinforcing layer 32 need not include the second helical layer 24.

As shown in FIG. 3, metal films 40 are laminated on the filaments in the hoop layer 20. The metal films 40 are laminated on the surface of the hoop layer 20 closer to the liner layer 30. Specifically, the metal films 40 and the like are formed by vacuum deposition, sputtering or the like on the surface of the filaments before the resin is cured, and the filaments on which the metal films 40 and the like have been formed are wound around the liner layer 30. The resin in the filaments is then cured to form the hoop layer 20. Since the filaments are wound without any gaps between them, the metal films 40 on the filaments contact each other along the axial direction D1 and form a metal layer extending along the axial direction D1. The metal layer made up of the metal films 40 is located between the hoop layer 20 and the liner layer 30. The metal films 40 include at least one of aluminum, copper, and gold, for example.

Moreover, metal films 42 are also laminated on the filaments in the first helical layer 22, and metal films 44 are also laminated on the filaments in the second helical layer 24. A metal layer made up of the metal films 42 is located between the hoop layer 20 and the first helical layer 22, and a metal layer made up of the metal films 44 is located between the first helical layer 22 and the second helical layer 24. The method of manufacturing the metal films 42 and 44 is similar to the method of manufacturing the metal films 40.

The thickness of each of the metal films 40, 42, and 44 in the radial direction D2 is, for example, several micrometers. The sum of the thicknesses of the metal films 40, 42, and 44 is preferably equal to or less than 500 micrometers.

### Effects of Embodiment

The fiber-reinforced plastic layer is formed by curing a resin that has been impregnated into fibers. Due to aging and other factors, the resin may peel off from the fibers. When cracks develop from points where the resin has peeled off from the fibers, the barrier performance of the tank 2 may be reduced.

According to the configuration of this embodiment, even when cracks develop in the hoop layer 20 and the like within the reinforcing layer 32, the metal films 40 and the like suppress the fluid in the tank 2 from permeating through the reinforcing layer 32. This allows the barrier performance of the tank 2 to be maintained.

In order to maintain the barrier performance of the tank 2, it is also conceivable that a polymer film is inserted instead of the metal films 40 and the like. However, in order to reliably block the permeation of the fluid, a polymer film thicker than the metal films 40 and the like is required. Therefore, employing the metal films 40 and the like makes it possible to maintain the barrier performance of the tank 2 without increasing the size of the tank 2.

In addition, the thermal conductivity of the metal films 40 is higher than that of the fiber-reinforced plastic. The metal layers made up of the metal films 40 and the like extend along the axial direction D1. Therefore, heat inside the tank 2 is transferred to the port 18 via the metal layers and is released to the outside of the tank 2. Adding the metal layers made up of the metal films 40 and the like makes it possible to help transfer the heat inside the tank 2 to the outside of the tank 2. In particular, the metal layer formed on the first helical layer 22 extends to the vicinity of the port 18 and contributes to heat dissipation from the port 18. Furthermore, the metal layers made up of the metal films 40 and the like can also improve the heat dissipation performance in a direction along the radial direction D2.

Furthermore, when cracks occur in the hoop layer 20 and the like, a load is also applied to the metal layer in contact with the hoop layer 20 and the like. By diagnosing sound caused by the load on the metal layer using the acoustic emission method (AE method), it is possible to detect signs of the development of cracks in the hoop layer 20 and the like. In particular, the breakage of the fibers and resin in the hoop layer 20 and the like is relatively instantaneous, whereas the breakage of the metal layer is relatively delayed. Although it is difficult to detect signs of the development of cracks using the AE method based on instantaneous sounds, it is possible to detect the signs using the AE method based on long sounds from the metal layer.

### Correspondence

The tank 2 and the tank body 10 are examples of a “tank” and a “tank body”, respectively. The storage space 12, the cylindrical portion 14, and the dome portion 16 are examples of a “storage space”, a “cylindrical portion”, and a “dome portion”, respectively. The liner layer 30 is an example of a “liner layer”. The hoop layer 20 is an example of a “fiber-reinforced plastic layer” and a “hoop layer”. The metal film 40 is an example of a “metal film”. The first helical layer 22 and the second helical layer 24 are examples of a “helical layer”.

### Second Embodiment

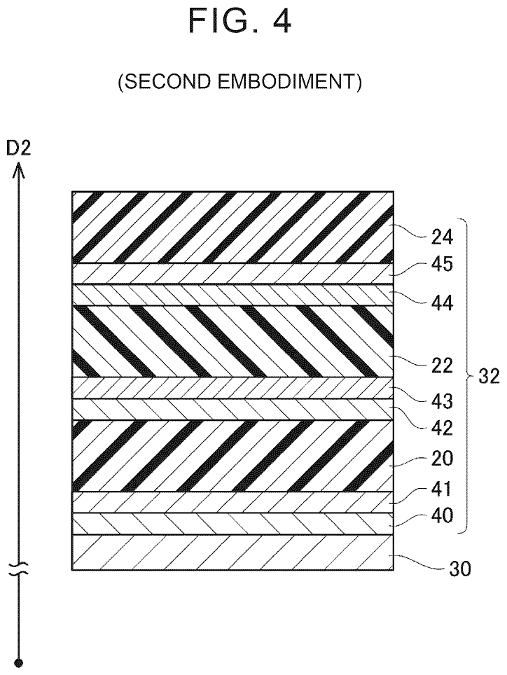

### Structure of Tank 2: FIG. 4

In this embodiment, an underlayer 41 is formed between the hoop layer 20 and the metal films 40. The underlayer 41 is made of, for example, nickel. In addition, underlayers 43 and 45 are formed between the first helical layer 22 and the metal films 42 and between the second helical layer 24 and the metal films 44, respectively.

### Third Embodiment

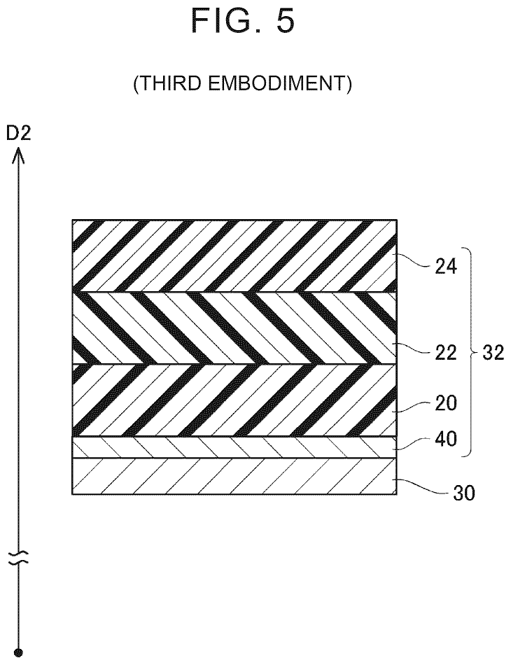

### Structure of Tank 2: FIG. 5

In this embodiment, the metal films 40 are formed on the hoop layer 20, while metal films are not formed on the first helical layer 22 and the second helical layer 24. That is, the metal layer made up of the metal films 40 is located on the storage space 12 side with respect to a central position in a thickness direction (i.e., the radial direction D2) of the fiber-reinforced plastic layer made up of the hoop layer 20, the first helical layer 22, and the second helical layer 24. The heat in the tank 2 is transferred through the liner layer 30 to the metal layer, then along the axial direction D1 to the port 18, and is released to the outside of the tank 2. In this embodiment, as in the first embodiment, it is possible to help transfer the heat in the tank 2 to the outside of the tank 2.

### Modifications of Third Embodiment

In a modification of this embodiment, a metal layer need not be formed on the hoop layer 20, and a metal layer may be formed on at least one of the first helical layer 22 and the second helical layer 24. In another modification, the first helical layer 22 may be formed on the liner layer 30, and the hoop layer 20 may be formed on the first helical layer 22. A metal layer may then be formed between the liner layer 30 and the first helical layer 22. The metal layer formed on the first helical layer 22 extends to the vicinity of the port 18 and contributes to heat dissipation from the port 18.

Points to be noted regarding the technique described in the embodiments will be described. The tank body 10 need not include the liner layer 30.

The metal layer may be formed on the fiber-reinforced plastic layer after the filaments are wound around the liner layer 30 and the resin is cured. In this case, the metal layer may be formed by a method, such as electroless plating.

What is claimed is:

1. A tank that stores a fluid, the tank comprising a tank body that defines a storage space for the fluid, wherein the tank body includes:
a fiber-reinforced plastic layer; and
a metal layer that is in contact with the fiber-reinforced plastic layer.

2. The tank according to claim 1, wherein the metal layer is located on the storage space side with respect to a central position in a thickness direction of the fiber-reinforced plastic layer.

3. The tank according to claim 1, wherein:
the tank body further includes a liner layer located between the storage space and the fiber-reinforced plastic layer; and
the metal layer is located between the liner layer and the fiber-reinforced plastic layer.

4. The tank according to claim 1, wherein:
the tank body includes a cylindrical portion and a pair of dome portions, the dome portions being provided on respective sides of the cylindrical portion;
the fiber-reinforced plastic layer includes a hoop layer having a structure in which a fiber-reinforced plastic filament is wound only around the cylindrical portion, and a helical layer in which the fiber-reinforced plastic filament is wound around the dome portions; and
the metal layer is made up of a metal film laminated on the filament in the helical layer.

5. The tank according to claim 1, wherein the metal layer includes at least one of aluminum, copper, and gold.
